(19) United States
(12) Patent Application Publication
(10) Pub. No.: US 2023/0296151 A1
(43) Pub. Date: Sep. 21, 2023

(54) BRAKE SHOE WITH A BRAKE LINING HAVING SPATIALLY VARYING THERMAL MATERIAL PROPERTIES

(71) Applicant: HL MANDO CORPORATION, Pyeongtaek-si (KR)

(72) Inventors: Hatem SHAHIN, Pfaffenhofen (DE); Lothar WAGNER, Simmern (DE); Kai BRAUN, Friedrichsdorf (DE); Volker KINDER, Russelsheim (DE)

(73) Assignee: HL MANDO CORPORATION, Pyeongtaek-si (KR)

(21) Appl. No.: 18/123,489

(22) Filed: Mar. 20, 2023

(30) Foreign Application Priority Data
Mar. 18, 2022 (DE) 102022202704.3

(51) Int. Cl. F16D 65/08; F16D 51/20; B60T 1/06

(52) U.S. Cl. CPC F16D 65/08; B60T 1/067; F16D 51/20; F16D 2069/002

(57) ABSTRACT

The invention relates to a brake shoe for a drum brake system, the brake shoe having a length configured to extend in a circumferential direction of a brake drum of the drum brake system, and a width configured to extend in an axial direction of the brake drum, wherein the brake shoe has spatially varying thermal properties along its length, in particular a change in heat capacity and/or a change in thermal expansion coefficient and/or a change in thermal conductivity. The invention also relates to a drum brake system having a brake shoe of the above-mentioned type.

### CROSS-REFERENCE TO RELATED APPLICATION

This application is based on and claims priority under 35 U.S.C. §119 to German Patent Application No. 102022202704.3, filed on Mar. 18, 2022 in the German Patent and Trade Mark Office, the disclosures of which are incorporated herein by reference.

### TECHNICAL FIELD

The present invention is in the field of mechanical engineering. It relates to a brake shoe for a drum brake system. It also relates to a drum brake system.

### BACKGROUND

Drum brake systems are complex brake systems which have some known disadvantages. One of the main technical problems of drum brakes is a non-symmetrical and uneven pressure and brake force applied by brake shoes on the drum.

For both Simplex and Duplex drum brakes, a force acting on the brake drum, effected by the brake shoes, is often not constant over a length of the brake shoe which results in an undesired temperature distribution and an uneven distribution of friction. This in turn reduces braking efficiency and causes dust, corrosion and noise. Moreover, the pressure and brake force differs between the leading brake shoe and the trailing brake shoe.

### SUMMARY

It is therefore an object of the present invention to eliminate at least some of the problems listed above.

This is achieved by a brake shoe according to claim 1. Advantageous embodiments can be found in the dependent claims and in the following description and the figures.

Accordingly, a brake shoe for a drum brake system has a length configured to extend in a circumferential direction of a brake drum of the drum brake system, and a width configured to extend in an axial direction of the brake drum. The brake shoe has spatially varying thermal properties along its length. For instance, the brake shoe may exhibit a change in heat capacity and/or a change in thermal expansion coefficient and/or a change in thermal conductivity along its length.

By way of this, a more even pressure distribution and/or a more even friction distribution during braking may be achieved. When the brake shoe is pressed against a brake drum for braking, heat is generated through friction. In an example, an initial pressure and/or initial friction between the brake shoe and the brake drum is not evenly distributed over the brake shoe, leading to an uneven heat distribution. The spatially varying thermal properties lead to a spatially variating reaction of the brake shoe to a heating up of the brake shoe. In particular, the spatially varying reaction of the brake shoe to heat may compensate the uneven pressure distribution and/or friction distribution. This may result in a more even pressure distribution and/or a more even friction distribution over the length of the brake shoe.

In an example, a drum brake system has a brake drum and at least one brake shoe according to the invention.

In the drum brake system, the brake drum may have a main rotating direction, corresponding for instance to a forward movement of a vehicle in which the brake system is provided. When the brake shoe is used in the brake drum system, it engages with a surface of the brake drum, a given portion of the brake drum first entering in contact with the brake shoe at its leading side, and then moving along the brake shoe to its trailing side. It may typically be determined from the brake shoe itself, which side is the trailing side and which side is the leading side.

In an example of the brake shoe, the heat capacity and/or the thermal conductivity and/or the thermal expansion coefficient increases from the leading side of the brake shoe to the trailing side of the brake shoe.

The brake shoe may be configured as a leading brake shoe of the drum brake system. The brake shoe may also be configured a trailing brake shoe of the drum brake system. In particular, a brake system is envisioned which has a leading brake shoe and a trailing brake shoe, wherein both the leading brake shoe and the trailing brake shoe are configured according to any of the embodiments shown and described herein.

In order to provide the spatially varying thermal properties, the brake shoe may comprise at least two segments, in particular at least three segments, with different thermal properties from one another. In particular the segments may have a different heat capacity and/or a different thermal expansion coefficient and/or a different thermal conductivity from one another. In an example, the heat capacity, thermal expansion coefficient and thermal conductivity is constant throughout each segment. I.e., the properties may change in a stepwise fashion from one segment to the next.

There may for instance be a total of two segments or of three segments or of four segments or of five segments in the brake shoe.

The at least two segments or the at least three segments are provided in a brake lining and/or in a lining holder of the at least one brake shoe. That means that it is possible to tune thermal properties by providing corresponding materials in the brake lining and/or in the lining holder.

In an example, the brake lining has two or more segments, a material differing from one segment to the next, to achieve the varying thermal properties. In this case, the lining holder may be uniform, without segments, or it may also comprise segments of varying thermal properties, adding to the desired effect.

In another example, the lining holder has two or more segments, a material differing from one segment to the next, to achieve the varying thermal properties. In this case, the brake lining may be uniform, without segments, or it may also comprise segments of varying thermal properties, adding to the desired effect.

The underlying concept is to adapt the individual material ingredients in each segment, wherein each material ingredient has a set of properties (both mechanical and thermal), so that in total the desired material properties per segment are created. This may be done both when the properties are modified in the brake lining and when the properties are modified in the lining holder.

It may for instance also be envisioned to have gradually varying thermal properties, for instance by having a gradually varying material composition, in particular a gradually varying material composition of the brake lining, but also of the lining holder.

In an example, the at least two segments or the at least three segments (which may be provided in the brake lining, in the lining holder, or in both the brake lining and the lining holder) comprise a first segment being a leading segment, and a second segment adjacent to the first segment. Therein the heat capacity and/or the thermal expansion coefficient and/or the thermal conductivity in the first segment may be at least 5 % or at least 10 % less than the heat capacity and/or the thermal expansion coefficient and/or the thermal conductivity in the second segment. For example, the heat capacity and/or the thermal expansion coefficient and/or the thermal conductivity in the first segment may be up to 20 % less than that of the second segment. The second segment may constitute a trailing segment, or there may be one or more further segments arranged after the second segment, further towards the trailing end of the brake shoe.

In an example, a third segment is provided adjacent to the second segment, i.e., opposite to the first segment, wherein the heat capacity and/or the thermal expansion coefficient and/or the thermal conductivity in the third segment is at least 5 % or at least 10 % more than the heat capacity and/or the thermal expansion coefficient and/or the thermal conductivity in the second segment. In an example, the heat capacity and/or the thermal expansion coefficient and/or the thermal conductivity in the third segment may be up to 20 % more than that of the second segment. The third segment may constitute a trailing segment, or there may be one or more further segments arranged after the third segment, further towards the trailing end of the brake shoe.

In the brake shoe, the spatially varying thermal properties may be provided in the brake lining of the brake shoe, wherein the brake lining may have a heat capacity that is in a range from 5 J/(Kg*K) to 20 J/(Kg*K), the heat capacity of the brake lining for instance varying by at least 10 % or at least 20 % along the length of the brake shoe. The indicated values of heat capacity may be defined at room temperature (20° C.).

Alternatively or additionally, in the brake shoe, the spatially varying thermal properties may be provided in the brake lining of the brake shoe, wherein the brake lining may have a volumetric thermal expansion coefficient that is in a range from 100*E-061/K to 300*E-061/K, the volumetric thermal expansion coefficient of the brake lining for instance varying by at least 10 % or at least 20 % along the length of the brake shoe. The indicated values of volumetric thermal expansion coefficient may be defined at room temperature (20° C.).

Alternatively or additionally, in the brake shoe, the spatially varying thermal properties may be provided in the brake lining of the brake shoe, wherein the brake lining may have a thermal conductivity that is in a range from 0.1 W/(m*K) to 0.8 W/(m*K), the thermal conductivity of the brake lining for instance varying by at least 10 % or at least 20 % along the length of the brake shoe. The indicated values of thermal conductivity may be defined at room temperature (20° C.).

In an example, the spatially varying thermal properties are additionally or alternatively provided in a lining holder of the at least one brake shoe. The lining holder may for instance comprise steel and/or cast iron.

In the brake shoe, the spatially varying thermal properties may be provided in the lining holder of the brake shoe, the lining holder for instance having a heat capacity that is in a range from 280 J/(Kg*K) to 420 J/(Kg*K), the heat capacity of the lining holder for instance varying by at least 10 % or at least 20 % along the length of the brake shoe. The indicated values of heat capacity may be defined at room temperature (20° C.).

Alternatively or additionally, in the brake shoe, the spatially varying thermal properties may be provided in the lining holder of the brake shoe, the lining holder for instance having a volumetric thermal expansion coefficient that is in a range from 24*E-061/K to 36*E-061/K, the volumetric thermal expansion coefficient of the lining holder for instance varying by at least 10 % or at least 20 % along the length of the brake shoe. The indicated values of volumetric thermal expansion coefficient may be defined at room temperature (20° C.).

Alternatively or additionally, in the brake shoe, the spatially varying thermal properties may be provided in the lining holder of the brake shoe, the lining holder for instance having a thermal conductivity that is in a range from 8 W/(m*K) to 18 W/(m*K), the thermal conductivity of the lining holder for instance varying by at least 10 % or at least 20 % along the length of the brake shoe. The indicated values of thermal conductivity may be defined at room temperature (20° C.).

The brake shoe may have a spatially varying friction coefficient along its length. This may contribute to achieving a desired uniform distribution of friction. The friction coefficient may for instance increase or decrease from the leading side to the trailing side.

If segments of the above-described type are provided, the friction coefficient may be different from one segment to the next.

Herein, a drum brake system for a vehicle is proposed. It comprises a brake drum, a leading brake shoe and a trailing brake shoe, wherein at least one of the leading brake shoe and the trailing brake shoe is a brake shoe according to any of the embodiments shown or described herein. In particular both the leading brake shoe and the trailing brake shoe may be brake shoes of this type.

In this drum brake system, it may be envisioned that the change in heat capacity and/or the change in thermal expansion coefficient and/or the change in thermal conductivity of the leading brake shoe is greater than the change in heat capacity and/or the change in thermal expansion coefficient and/or the change in thermal conductivity of the trailing brake shoe.

### BRIEF DESCRIPTION OF DRAWINGS

The invention will now be explained in an exemplary fashion with reference to the appended figures. Therein,

FIG. 1 shows a drum brake system with two brake shoes and a pressure distribution along a length of the brake shoes,

FIG. 2 shows a non-uniform pressure distribution according to the state of the art,

FIG. 3 shows a uniform pressure distribution,

FIG. 4 shows two brake shoes of a drum brake system, each brake shoe having three segments,

FIG. 5 shows two brake shoes of a drum brake system, each brake shoe having two segments provided in a brake lining,

FIG. 6 shows two brake shoes of a drum brake system, each brake shoe having three segments provided in a brake lining,

FIG. 7 shows two brake shoes of a drum brake system, each brake shoe having four segments provided in a brake lining,

FIG. 8 shows two brake shoes of a drum brake system, each brake shoe having two segments provided in a brake lining and in a lining holder,

FIG. 9 shows two brake shoes of a drum brake system, each brake shoe having three segments provided in a brake lining and in a lining holder, and

FIG. 10 shows two brake shoes of a drum brake system, each brake shoe having three segments provided in a lining holder.

### DETAILED DESCRIPTION

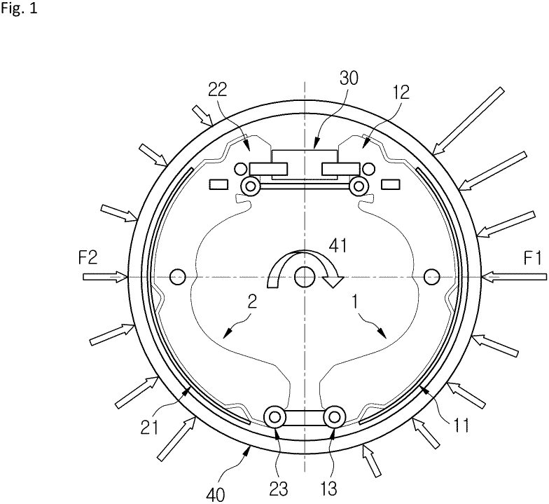

FIG. 1 schematically shows a drum brake system for a vehicle. The drum brake system has a brake drum 40 with a main rotating direction 41 (indicated by an arrow), which corresponds to the vehicle moving in a forward direction. The drum brake system has a back plate assembly with two brake shoes 1, 2. The brake shoes 1, 2 each have a brake lining 11, 21, made of a friction material, and a lining holder 12, 22, made for instance of cast metal or steel. The brake shoes 1, 2 each have a pivot axis 13, 23 at the bottom, where they are pivotably connected to a back plate, and there is an actuator 30 provided near the top of the brake shoes, configured for pressing the brake shoes 1, 2 outward and against the brake drum 40 for braking. Accordingly, and in view of the main rotating direction 41 of the brake drum, the brake shoe 1 on the right is a leading brake shoe 1, and the brake shoe 2 on the left is a trailing brake shoe.

In FIG. 1, a brake force distribution F1 for the leading brake shoe 1, and a brake force distribution F2 for the trailing brake shoe 2 is indicated by way of arrows, longer arrows indicating higher brake force, and shorter arrows indicating lower brake force. For both brake shoes 1, 2 the brake force decreases from the leading edge to the trailing edge. Moreover, brake force of the trailing brake shoe 2 is less than brake force at the leading brake shoe 1. These distributions are due to the mechanical setup of the drum brake and may for instance result in less than optimal stopping power and uneven heating and wear.

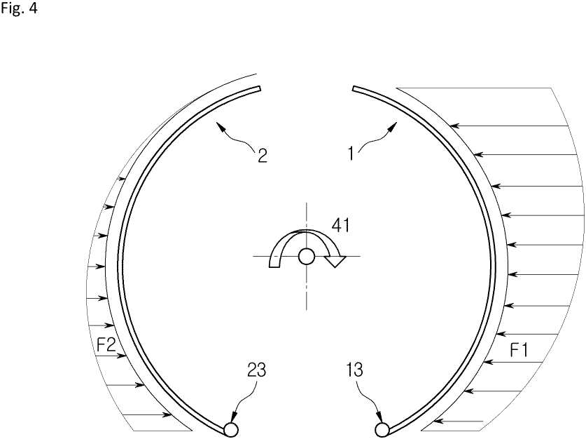

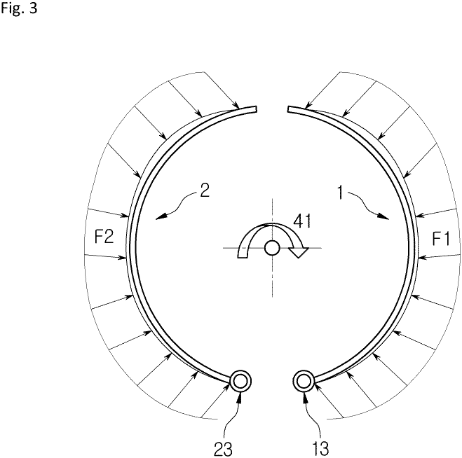

Turning to FIGS. 2 and 3, a typical uneven force distribution is shown in FIG. 2, and an even pressure distribution is shown in FIG. 3. It is an object of the invention, to enable a more evenly distributed brake force, i.e., go from the force distribution of FIG. 2 towards the force distribution of FIG. 3.

This may be accomplished by providing the brake system with brake shoes as shown and explained in either of the following figures.

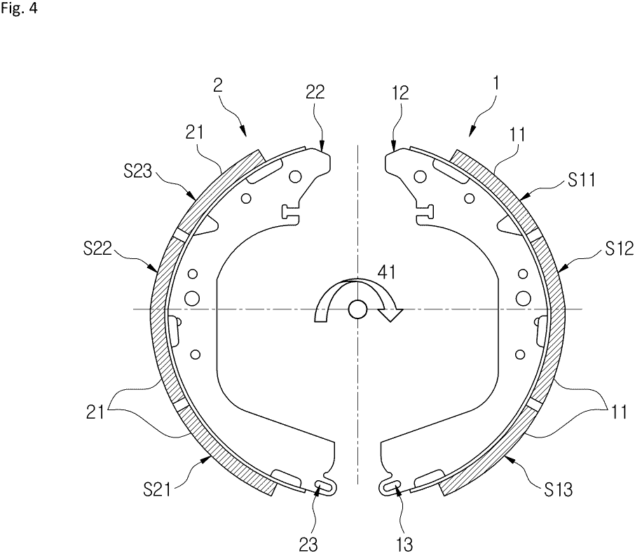

FIG. 4 shows an embodiment of a pair of brake shoes 1, 2, aimed at establishing a more evenly distributed brake force.

The brake shoes 1, 2 each have a brake lining 11, 21, made of a friction material, and a lining holder 12, 22, made for instance of cast metal or steel. Each of the brake shoes 1, 2 has a length configured to extend in a circumferential direction of the brake drum 40 of the drum brake system, and a width configured to extend in an axial direction of the brake drum 40.

Both brake shoes 1, 2 have spatially varying thermal properties along their length, wherein their heat capacity and thermal expansion coefficient and thermal conductivity changes from their leading side to their trailing side.

Specifically, for the leading brake shoe 1 and for the trailing brake shoe 2, the heat capacity and the thermal conductivity and the thermal expansion coefficient increases from the leading side of the respective brake shoe 1, 2 towards its trailing side. I.e., for the leading brake shoe 1 on the right, the leading side is at the top, and the parameters increase from top to bottom, and for the trailing brake shoe 2 on the left, the leading side is at the bottom, and the parameters increase from bottom to top.

The idea is to match the thermal properties at the different positions to meet a target of relatively constant friction values along with the total circumference of the drum.

In a drum brake system for a vehicle, for instance as shown in FIG. 1, the leading brake shoe 1 and the trailing brake shoe 2 of FIG. 4 may be provided.

The change in heat capacity and/or the change in thermal expansion coefficient and/or the change in thermal conductivity of the leading brake shoe 1 is greater than the change in heat capacity and/or the change in thermal expansion coefficient and/or the change in thermal conductivity of the trailing brake shoe 2, as will be explained further here below.

Each of the leading brake shoe 1 and the trailing brake shoe 2 comprises three segments S11, S12, S13; S21, S22, S23, with different thermal properties from one another, in particular with different heat capacity and different thermal expansion coefficient and different thermal conductivity from one another.

The segments S11, S12, S13; S21, S22, S23 are provided in the linings 11, 21.

The leading brake shoe 1 has a first segment S11 which constitutes a leading segment, a second segment S12 which constitutes a central segment, and a third segment S13 which constitutes a trailing segment. In the second segment S12, the central segment, the brake lining 11 has a heat capacity with a nominal value that is in a range from 5 J/(Kg*K) to 20 J/(Kg*K), for instance between 7 J/(Kg*K) and 17 J/(Kg*K), and a volumetric thermal expansion coefficient with a nominal value that is in a range from 100*E-06 1/K to 300*E-061/K, for instance between 130*E-061/K to 270*E-061/K, and a thermal conductivity with a nominal value that is in a range from 0.1 W/(m*K) to 0.8 W/(m*K), for instance between 0.2 W/(m*K) and 0.7 W/(m*K). Values are in each case given at 20° C. In the first segment S11 of the leading brake shoe 1, the brake lining 11 exhibits, for each of heat capacity, thermal expansion coefficient and thermal conductivity, a nominal value that is reduced by 10 to 20 % as compared to that of the central second segment S12. In the third segment S13, the trailing segment of the leading brake shoe 1, the brake lining 11 exhibits, for each of heat capacity, thermal expansion coefficient and thermal conductivity, a nominal value that is increased by 10 to 20 % as compared to that of the central second segment S12.

In the case of the trailing brake shoe 2, there is also a first segment S21 which constitutes a leading segment, a second segment S22 which constitutes a central segment, and a third segment S23 which constitutes a trailing segment. In the second segment S22, the central segment, the brake lining 21 has a heat capacity with a nominal value that is in a range from 5 J/(Kg*K) to 20 J/(Kg*K), for instance between 7 J/(Kg*K) and 17 J/(Kg*K), and a volumetric thermal expansion coefficient with a nominal value that is in a range from 100*E-061/K to 300*E-061/K, for instance between 130*E-061/K to 270*E-061/K, and a thermal conductivity with a nominal value that is in a range from 0.1 W/(m*K) to 0.8 W/(m*K), for instance between 0.2 W/(m*K) and 0.7 W/(m*K). Values are in each case given at 20° C. In the first segment S21 of the trailing brake shoe 2, the brake lining 21 exhibits, for each of heat capacity, thermal expansion coefficient and thermal conductivity, a nominal value that is reduced by 5 to 20 % as compared to that of the central second segment S22. In particular, the reduction may be less than the reduction between segments S11 and S12 of the leading brake shoe 1. In the third segment S23, the trailing segment of the trailing brake shoe 2, the brake lining 21 exhibits, for each of heat capacity, thermal expansion coefficient and thermal conductivity, a nominal value that is increased by 10 to 25 % as compared to that of the central second segment S22. In particular, this increase may be larger than the increase between segments S12 and S13 of the leading brake shoe 1.

The friction materials which form the linings consist of a number of different substances, which affect friction, adhesion and thermal properties. The composition of these substances is changed from one segment to the next, to achieve the above-identified target values, leading to a homogeneous brake force and temperature distribution over the total length of both linings 11, 21.

In the brake shoes 1, 2 a spatially varying friction coefficient along their lengths may additionally be provided.

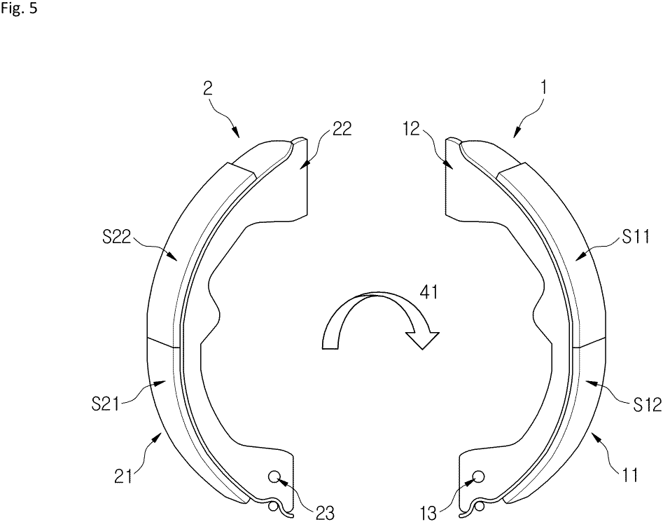

FIG. 5 shows a pair of brake shoes 1, 2, comprising a leading brake shoe 1 and a trailing brake shoe 2. Each of the brake shoes 1, 2 has two segments S11, S12; S21, S22, in each case provided in the lining 11, 21. For each of the brake shoes 1, 2, the heat capacity and/or the thermal expansion coefficient and/or the thermal conductivity of the trailing segment S12, S22 is by at least 20 % higher than in the leading segment S11, S21.

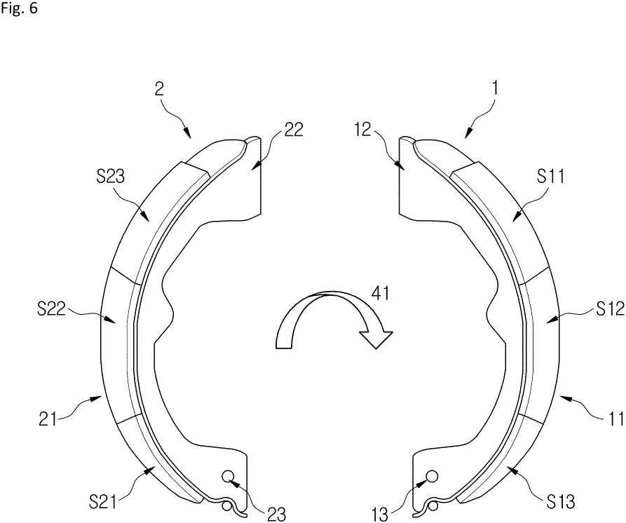

FIG. 6 shows a pair of brake shoes 1, 2, comprising a leading brake shoe 1 and a trailing brake shoe 2. Each of the brake shoes 1, 2 has three segments S11, S12, S13; S21, S22, S23, in each case provided in the lining 11, 21. For each of the brake shoes 1, 2, the heat capacity and/or the thermal expansion coefficient and/or the thermal conductivity increases from the respective leading segment S11, S21 to the respective central segment S12, S22 by at least 10 %, and then increases again, from the respective central segment S12, S22 to the respective trailing segment S13, S23, by another at least 10 %.

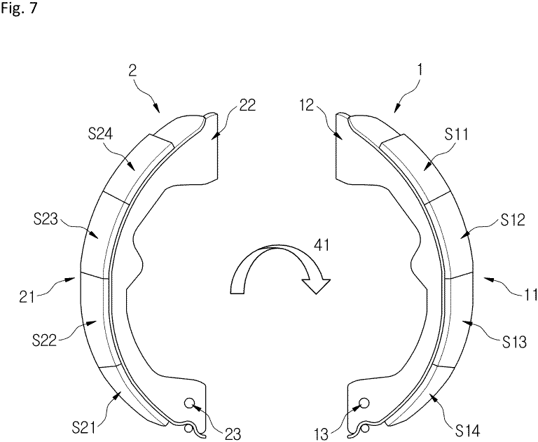

FIG. 7 shows a pair of brake shoes 1, 2, comprising a leading brake shoe 1 and a trailing brake shoe 2. Each of the brake shoes 1, 2 has four segments S11, S12, S13, S14; S21, S22, S23, S24 in each case provided in the lining 11, 21. For each of the brake shoes 1, 2, the heat capacity and/or the thermal expansion coefficient and/or the thermal conductivity increases from the respective first, leading segment S11, S21 to the respective second segment S12, S22 by at least 5 %, and then increases again, from the respective second segment S12, S22 to the respective third segment S13, S23, by another at least 5 %, and then increases again from the respective third segment S13, S23 to the respective fourth, trailing segment S14, S24, by another at least 5 %.

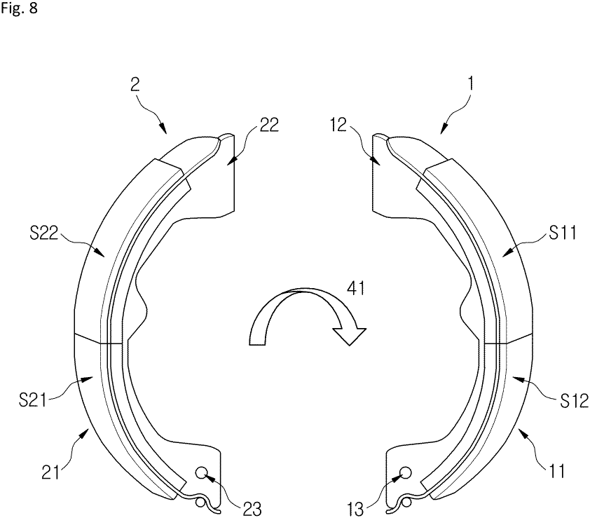

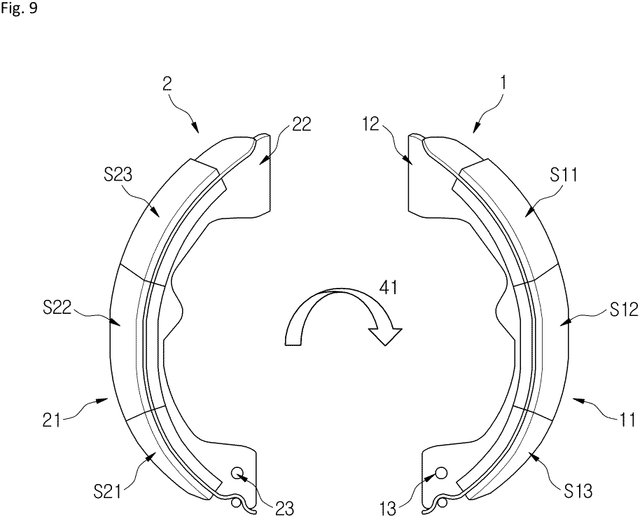

FIGS. 8 and 9 relate to embodiments of brake shoes, wherein spatially varying thermal properties are provided in a lining holder 12, 22 of the brake shoe 1, 2, the lining holder 12, 22 comprising steel and/or cast iron. Therein, varying thermal properties are also provided in the linings 11, 21. In these cases, a combination of modifications in both lining and lining holder is advantageously exploited to achieve the desired goal.

Referring to both FIGS. 8 and 9, the lining holders 12, 22 have a heat capacity that is in a range from 280 J/(Kg*K) to 420 J/(Kg*K), and a volumetric thermal expansion coefficient that is in a range from 24*E-061/K to 36*E-06⅟K, and a thermal conductivity that is in a range from 8 W/(m*K) to 18 W/(m*K). In particular, segments S11, S12; S21, S22, (and S13, S23, in the case of FIG. 9) are provided in the lining holders 12, 22, wherein the heat capacity, volumetric thermal expansion coefficient and thermal conductivity of the lining holders 12, 22 varies from one segment to the next, each of these parameters increasing by at least 10 % over the length of the brake shoe 1, 2, from the leading segments S11, S21, to the trailing segments S12, S22 or S13, S23. To this end, the lining holders 12, 22 comprise varying material compositions in the various segments, wherein heat capacity, volumetric thermal expansion coefficient and thermal conductivity are tuned by changing the constituents or their concentration from one segment to the next.

In the case of FIG. 8, there are, in each brake shoe 1, 2, two segments S11, S12, S21, S22 provided in both the brake lining 11, 21 and the lining holder 12, 22. Varying heat capacity, volumetric thermal expansion coefficient and thermal conductivity are provided in both the brake linings 11, 21 and the lining holders 12, 22.

In the case of FIG. 9, there are, in each brake shoe 1, 2, three segments S11, S12, S13, S21, S22, S23 provided in both the brake lining 11, 21 and the lining holder 12, 22. Varying heat capacity, volumetric thermal expansion coefficient and thermal conductivity are provided in both the brake linings 11, 21 and the lining holders 12, 22.

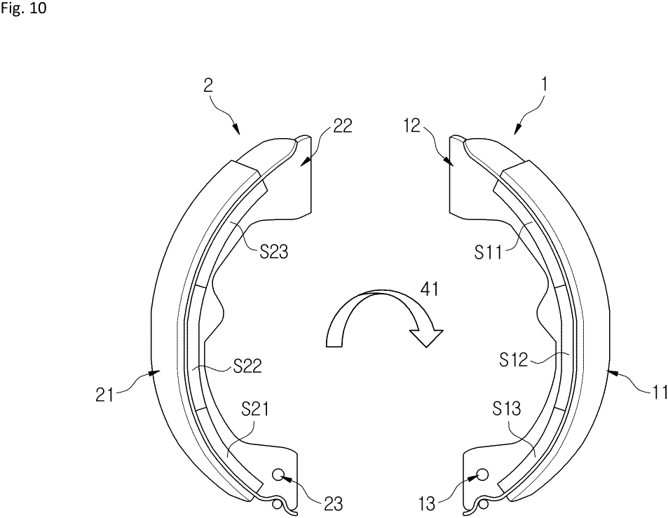

FIG. 10 shows a pair of brake shoes 1, 2, wherein spatially varying thermal properties are provided in a lining holder 12, 22 of the brake shoes 1, 2, the lining holder 12, 22 comprising steel and/or cast iron. Therein, the heat capacity, volumetric thermal expansion coefficient and thermal conductivity of the lining holders 12, 22 increases by at least 10 % from the respective leading segments S11, S21 to the respective central segments S12, S22, and then increases again by at least 10%, to the respective trailing segments S13, S23. The linings 11, 21 may be provided with constant material properties throughout.

What is claimed is:

1. A brake shoe for a drum brake system, the brake shoe having a length configured to extend in a circumferential direction of a brake drum of the drum brake system, and a width configured to extend in an axial direction of the brake drum, wherein the brake shoe has spatially varying thermal properties along its length, in particular a change in heat capacity and/or a change in thermal expansion coefficient and/or a change in thermal conductivity.

2. The brake shoe according to claim 1, having a leading side and a trailing side, wherein the heat capacity and/or the thermal conductivity and/or the thermal expansion coefficient increases from the leading side of the brake shoe to the trailing side.

3. The brake shoe according to claim 1, comprising at least two segments, with different thermal properties from one another, in particular with different heat capacity and/or different thermal expansion coefficient and/or different thermal conductivity from one another.

4. The brake shoe according to claim 3, wherein the at least two segments are provided in a brake lining and/or in a lining holder of the at least one brake shoe.

5. The brake shoe according to claim 3, comprise a first segment being a leading segment, and a second segment adjacent to the first segment, wherein the heat capacity and/or the thermal expansion coefficient and/or the thermal conductivity in the first segment is at least 5 % less than the heat capacity and/or the thermal expansion coefficient and/or the thermal conductivity in the second segment.

6. The brake shoe according to claim 1, wherein the at least three segments are provided in a brake lining and/or in a lining holder of the at least one brake shoe.

7. The brake shoe according to claim 6, wherein the at least three segments are provided in a brake lining and/or in a lining holder of the at least one brake shoe.

8. The brake shoe according to claim 6, comprise a first segment being a leading segment, and a second segment adjacent to the first segment, wherein the heat capacity and/or the thermal expansion coefficient and/or the thermal conductivity in the first segment is at least 5 % less than the heat capacity and/or the thermal expansion coefficient and/or the thermal conductivity in the second segment.

9. The brake shoe according to claim 8, comprising a third segment adjacent to the second segment, wherein the heat capacity and/or the thermal expansion coefficient and/or the thermal conductivity in the third segment is at least 5 % more than the heat capacity and/or the thermal expansion coefficient and/or the thermal conductivity in the second segment.

10. The brake shoe according to claim 1, wherein the spatially varying thermal properties are provided in a brake lining of the brake shoe, the brake lining having:
a heat capacity that is in a range from 5 J/(Kg*K) to 20 J/(Kg*K), the heat capacity of the brake lining varying by at least 10 % along the length of the brake shoe, and/or
a volumetric thermal expansion coefficient that is in a range from 100*E-061/K to 300*E-061/K, the volumetric thermal expansion coefficient of the brake lining varying by at least 10 % along the length of the brake shoe, and/or
a thermal conductivity that is in a range from 0.1 W/(m*K) to 0.8 W/(m*K), the thermal conductivity of the brake lining varying by at least 10 % along the length of the brake shoe.

11. The brake shoe according to claim 1, wherein the spatially varying thermal properties are provided in a lining holder of the brake shoe, the lining holder comprising steel and/or cast iron.

12. The brake shoe according to claim 1, wherein the spatially varying thermal properties are provided in a lining holder of the brake shoe, the lining holder having:
a heat capacity that is in a range from 280 J/(Kg*K) to 420 J/(Kg*K), the heat capacity of the lining holder varying by at least 10 % along the length of the brake shoe, and/or
a volumetric thermal expansion coefficient that is in a range from 24*E-061/K to 36*E-061/K, the volumetric thermal expansion coefficient of the lining holder varying by at least 10 %along the length of the brake shoe, and/or
a thermal conductivity that is in a range from 8 W/(m*K) to 18 W/(m*K), the thermal conductivity of the lining holder varying by at least 10 % along the length of the brake shoe.

13. The brake shoe according to claim 1, wherein the brake shoe has a spatially varying friction coefficient along its length.

14. A drum brake system for a vehicle, having a brake drum, a leading brake shoe and a trailing brake shoe, wherein at least one of the leading brake shoe and the trailing brake shoe, is a brake shoe according to claim 1, in particular both the leading brake shoe and the trailing brake shoe are brake shoes according to any of the preceding claims .

15. The drum brake system according to claim 14, wherein the change in heat capacity and/or the change in thermal expansion coefficient and/or the change in thermal conductivity of the leading brake shoe is greater than the change in heat capacity and/or the change in thermal expansion coefficient and/or the change in thermal conductivity of the trailing brake shoe.
